(19) United States
(12) Patent Application Publication
(10) Pub. No.: US 2015/0066314 A1
(43) Pub. Date: Mar. 5, 2015

(54) SYSTEM FOR DISPENSING AGRICULTURAL PRODUCTS IN SPECIFIED GROUPINGS

(71) Applicant: AMERICAN VANGUARD CORPORATION, Newport Beach, CA (US)

(72) Inventors: LARRY M. CONRAD, Walker, IA (US); REX A. RYSDAM, Bloomfield, IA (US); NATHANIEL R. CLAUSSEN, Golden Valley, MN (US)

(21) Appl. No.: 14/468,973

(22) Filed: Aug. 26, 2014

Related U.S. Application Data
(60) Provisional application No. 61/870,667, filed on Aug. 27, 2013.

(51) Int. Cl. A01C 21/00; A01C 23/00; A01N 25/00; A01C 7/06

(52) U.S. Cl. CPC A01C 21/005; A01C 7/06; A01C 23/007; A01N 25/00
USPC 701/50

(57) ABSTRACT

A system for dispensing agricultural products includes: a) a master controller; b) a power distribution box; c) agricultural product containers; d) meter devices; and, e) secondary controllers. The power distribution box is operatively connected to the master controller and a secondary power source. The meter devices are operatively connected to the product containers and configured to dispense products at metered rates. Each secondary controller receives command data from the master controller, and controls the meter devices for dispensing in response to the command data. The master controller and the secondary controllers are configured to provide operator defined groups of rows. Each of the rows in a group has an operator assigned dispensing rate and operator assigned product. The dispensing rate and product are controllable by the operator during operation according to planting needs.

### CROSS REFERENCE TO RELATED APPLICATIONS

The present application claims benefit of U.S. Provisional Application. No. 61/870,667 filed Aug. 27, 2013, entitled SYSTEM FOR DISPENSING AGRICULTURAL PRODUCTS IN SPECIFIED GROUPINGS, the entire contents of which are hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to material delivery systems for agricultural products and more particularly to material dispensing systems using distributed processing.

2. Description of the Related Art

In markets requiring the usage of chemicals, often hazardous substances, the Environmental Protection Agency and other regulatory bodies are imposing stricter regulations on the transportation, handling, dispersion, disposal, and reporting of actual usage of chemicals. These regulations, along with public health concerns, have generated a need for products that address these issues dealing with proper chemical handling.

To reduce the quantity of chemicals handled, the concentration of the chemical, as applied, has been increasing. This has raised the cost of chemicals per unit weight and has also required more accurate dispensing systems. For example, typical existing systems for agricultural product dispensing use a mechanical chain driven dispenser. Normal wear and tear on these mechanical dispensers can alter the rate of product applied by as much as 15%. For one typical chemical, Force®, a pyrethroid type insecticide by Syngenta, an over-application rate of 15% can increase the cost of the insecticide by $1500 over 500 acres.

Since many of the current agricultural product systems are mechanical systems, any record keeping and reporting must generally be kept manually.

The foregoing illustrates limitations known to exist in present material delivery systems. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In a broad aspect, the present invention is embodied as a system for dispensing agricultural products including: a) a master controller; b) a power distribution box; c) a plurality of agricultural product containers; d) a plurality of meter devices; and, e) a plurality of secondary controllers. The power distribution box is operatively connected to the master controller and a secondary power source. The meter devices are operatively connected to the product containers and configured to dispense agricultural products at metered rates from the containers to rows in a field. The secondary controllers actuate the meter devices. Each secondary controller receives command data from the master controller, via the power distribution box, and controls the meter devices for dispensing in response to the command data. The master controller and the secondary controllers are configured to provide operator defined groups of rows. Each of the rows in a group has an operator assigned dispensing rate and operator assigned agricultural product. The dispensing rate and agricultural product are controllable by the operator during operation according to planting needs. Typically, the groups of rows may include multiple groups of rows that the master controller and the secondary controller are configured to control simultaneously.

In another broad aspect, the present invention is embodied as a method for dispensing agricultural products. A system is provided that is arranged and constructed to dispense agricultural products from a plurality of agricultural product containers. The system for dispensing includes a master controller, a plurality of meter devices operatively connected to the product containers and configured to dispense agricultural products at metered rates from the containers to rows in a field, and a plurality of secondary controllers for actuating the plurality of meter devices. Each secondary controller receives command data from the master controller and controls the meter devices for dispensing in response to the command data. Groups of rows are defined, each of the rows in a group having a defined dispensing rate and defined agricultural product. Agricultural products are dispensed in accordance with the defined groups of rows

### BRIEF DESCRIPTION OF THE DRAWINGS

FIG. 1 is a simplified diagram showing a system for dispensing agricultural products of the present invention.

FIG. 2 is a side view of one embodiment of an electromechanical metering system for use with the system shown in FIG. 1.

FIG. 3 is a schematic diagram of the system shown in FIG. 1.

FIG. 4 is a diagrammatic illustration of a planter in accordance with the principles of the present invention showing a row grouping.

FIG. 5 is schematic illustration of an alternative embodiment of a metering system.

The same elements or parts throughout the figures of the drawings are designated by the same reference characters, while equivalent elements bear a prime designation.

### DETAILED DESCRIPTION OF THE INVENTION

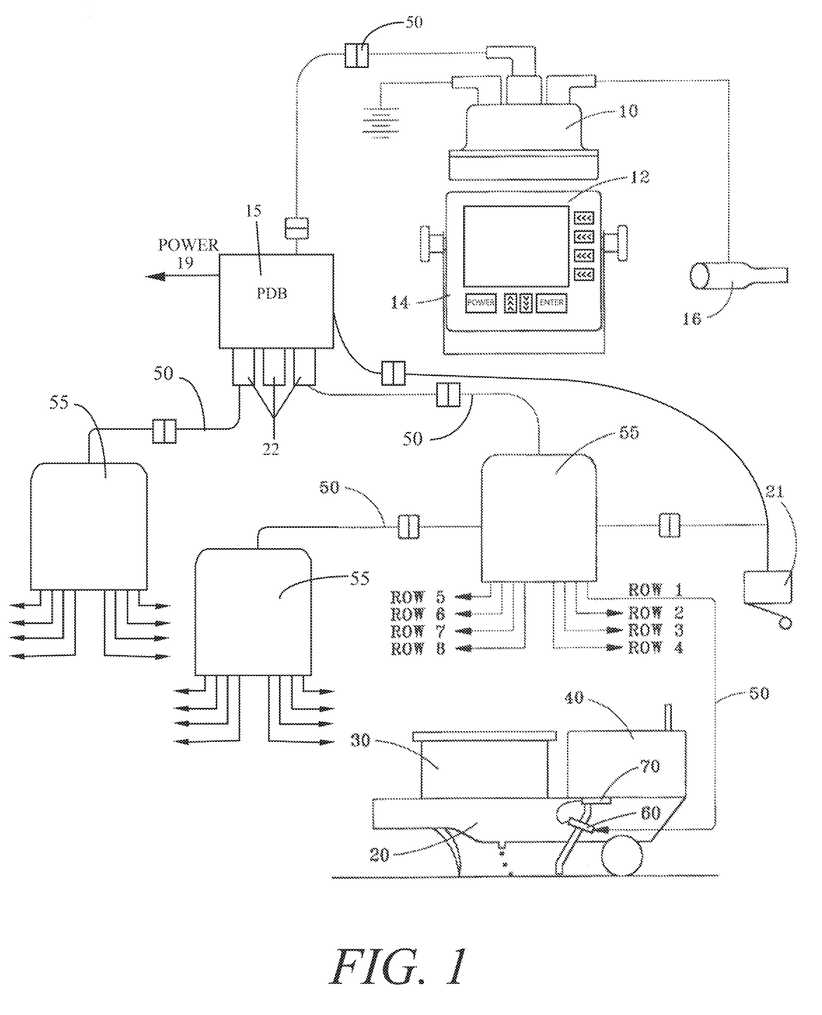

Referring now to the drawings and the characters of reference marked thereon, FIG. 1 shows a simplified diagram of a planter 20 incorporating a distributed control material dispensing system. The material dispensing system of the present invention may be used with other types of agricultural implements, but is primarily used with seed planting equipment. Although the Figures show a single row of planting equipment, typical planters include multiple rows, for example, 48 or more.

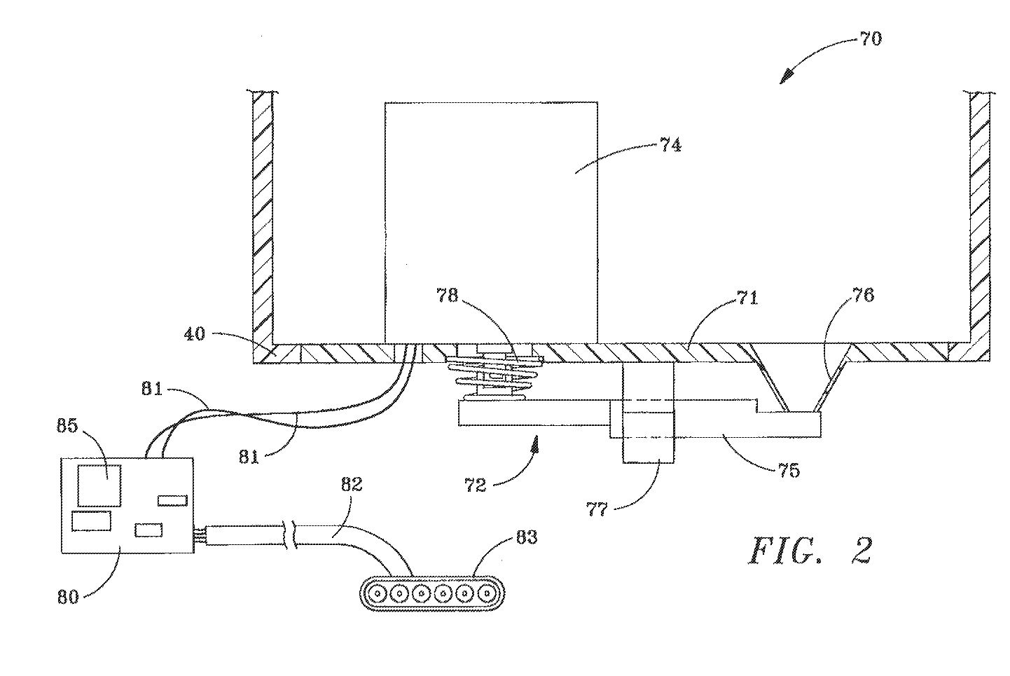

The distributed control system includes a main microcontroller 10 which communicates to a plurality of sub-controllers 60. (As used herein the term sub-controller may alternatively be referred to as a secondary controller, slave controller, or row controller.) The sub-controllers 60 implement commands received from the main control unit 10 by applying electric power to a metering device 72. The agricultural product container 40 may contain a memory device 85 for retaining information pertaining to the material in the container 40 and to the metering device 72 (see FIG. 2). This information is used by the main control unit (i.e. main microcontroller or master controller 10) and the sub-controllers 60 to properly dispense the product.

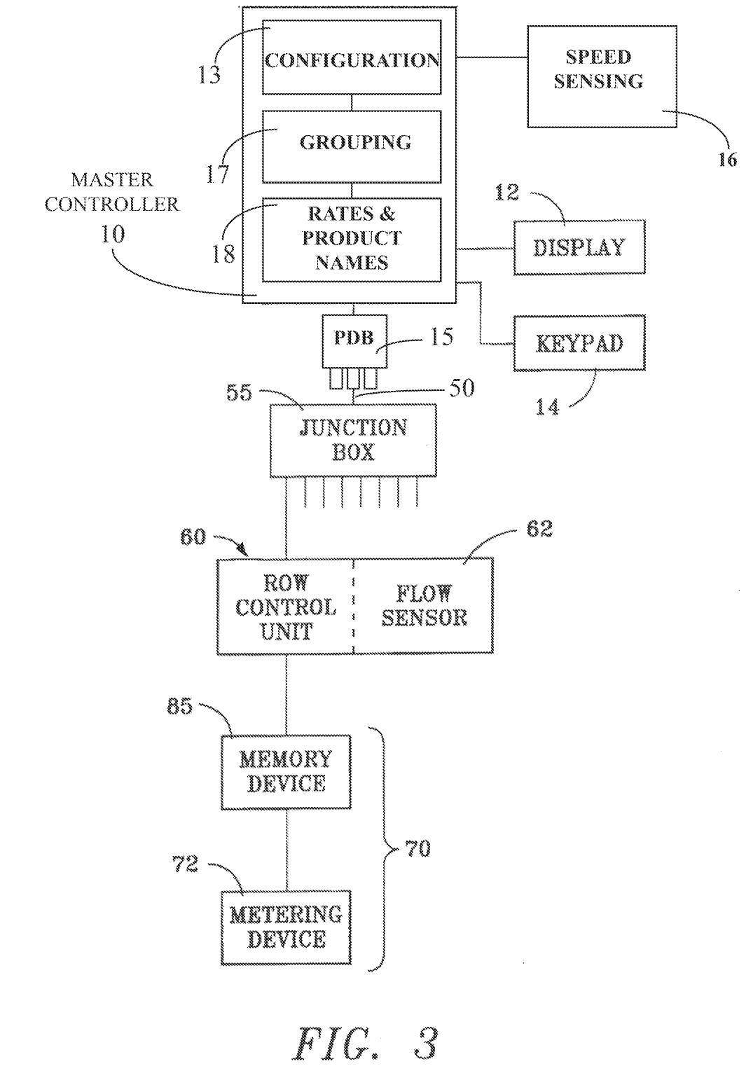

The material dispensing system shown in the figures is a distributed control system that employs a master microcontroller computer 10 located in the operator's cab. Typically, the material dispensing system is used in conjunction with a seed planter 20 which is attached to and pulled by a farmer's tractor (not shown). Each row of the seed planter 20 includes a seed hopper and seed planting mechanism 30 and an agricultural product container (i.e. typically a product container) 40 and associated dispensing mechanism (i.e. meter system) 70. Agricultural products include, but are not limited to, insecticides, herbicides, fungicides, fertilizers and other agricultural chemicals. Other agricultural products may include growth hormones, growth promotion products, and other products for enhancing crop production. This master or main controller 10 distributes command and control information via a high speed serial communications link 50, via a power distribution box 15, to sub-controllers 60 connected to individual meter systems 70. Each row corresponds to one row in the field being planted. Each individual meter system 70 is controlled by its own slave or row controller 60. The meter system 70 includes an electronic memory circuit 80 and a metering or dispensing device 72 (see FIG. 2). The meter system 70 can be permanently attached to the product container 40. Preferably, the meter system 70 is attached using a known tamper evident securing system. The row controller 60 includes a material flow sensor 62 (see FIG. 3) which is integral with the row controller 60. The material flow sensor 62 detects the presence or absence of flow from the product container 40

The main microcontroller unit 10 may include a display 12 and keypad 14 for operator interface. A speed sensing device such as radar, GPS, or wheel speed sensor 16 is connected to the main control unit 10 to provide ground speed. Ground speed is used to modify the material dispensing rate to account for the planter's speed. The main control unit 10 is connected to a plurality of junction boxes 55. The junction boxes 55 are operatively positioned between a power distribution box 15 and the secondary controllers 60 by a high speed serial communications link 50. The main controller 10 is in constant communication through the serial communications link 50 to the secondary controllers 60 located on the planters 20.

The secondary controllers (i.e. row control units) 60 allow a method of multiplexing signals going to the main controller 10. A main benefit is that the main controller 10 can control a planter with only nine wires going to a junction box 55. One pair of wires is used for serial communications, three pairs of wires are provided for power to the row control units 60 and to the metering devices 72. Three pairs of wires are used for power to more evenly distribute the current requirements. The power distribution box 15 obviates the need for power to be supplied by the master controller to the secondary controllers. The power distribution box 15 is independently connected to a power source as indicated by numeral designation 19. The power distribution box 15 is also connected to a lift switch 21. The power distribution box 15 has three serial ports 22 for connection to the junction boxes 55. It includes suitable electronic overload protectors to prevent damage to the system.

The main controller 10 also contains a suitable non-volatile memory unit, such as “flash” memory, a memory card, etc. Information pertaining to the usage and application of agricultural products is stored in this non-volatile memory unit. This information is used to prepare printed reports which meet EPA reporting requirements. Currently, farmers prepare these written reports manually.

A preferred junction box 55 can connect up to eight row control units 60 to the power distribution box 15. If the planter 20 has more than eight rows, additional junction boxes 55 can be connected to the power distribution box 15. The lift switch 21 is connected to the power distribution box 15. This switch indicates when the planter 20 is not in an operating position. Other interfaces to the main control unit 10 may be provided such as serial or parallel links for transmitting information to other computer systems or printers.

The row control unit 60 has memory devices and logic devices within to modify and implement the commands from the main controller 10. The row control unit 60 can read information from a container memory circuit 80 (see FIG. 2) attached to the container 40 and may manipulate the commands from the main controller 10 to properly operate the metering device 72. For example, if the concentration of product on row 1 is different than the concentration of product on row 8, the row control unit 60 can modify the commands of the main controller 10 to properly dispense products from all rows. The row control unit 60 also reads metering device 72 calibration data from the container memory circuit 80 and modifies the main controller 10 commands to account for differences in performance of different metering devices.

The row control unit 60 allows the possibility to completely change the programmed functions of the main controller 10. As an example, if a pre-programmed row control unit 60 is placed on a liquid herbicide sprayer, the main controller 10 would be able to read the dispenser type information and operate as a liquid sprayer controller.

The preferred embodiment shown in the figures uses one row control unit 60 to control one metering device and memory unit 70. A row control unit 60 can control more than one device, for example, two metering device and memory units 70 or one metering device and memory unit 70 and one seed hopper and seed planting mechanism 30.

Each container 40 includes a metering or dispensing device 72 which allows controlled application rates under different conditions. The metering device 72 described herein is an electromechanical solenoid driven device for dry granular material. Other type of dispensers may be used for other materials, such as liquids. One type of metering device is described in U.S. Pat. No. 7,171,913, entitled “Self-Calibrating Meter With In-Meter Diffuser”. Another type of metering device is described in U.S. Pat. No. 5,687,782, entitled “Transfer Valve For a Granular Materials Dispensing System”. Another type of metering device is described in U.S. Pat. No. 5,524,794, entitled “Metering Device for Granular Materials”. Another type of metering device for dry granular material is described in U.S. Pat. No. 5,156,372, entitled Metering Device for Granular Materials. U.S. Pat. Nos. 7,171,913; 5,687,782; 5,524,794; and, 5,156,372 are incorporated herein by reference in their entireties.

As will be discussed below in detail, the master controller 10 and the secondary controllers 60 are configured to provide operator defined multiple groups of rows. Each of the rows in a group has an operator assigned dispensing rate and operator assigned agricultural product. The dispensing rate and agricultural product are controllable by the operator during operation, according to planting needs. The master controller 10 and the secondary controllers 60 are configured to control multiple groups of rows simultaneously. A group of rows may include a single row. Thus, for example, on a 48 row planter, 48 different products can be applied, each at its own specific rate. Furthermore, each of the products and their corresponding rate can be recorded.

Referring now to FIG. 2, a side view of the meter system is illustrated, designated generally as 70. The meter system 70 includes a metering device 72 and memory unit 80. A base plate 71 is fastened to the bottom of the container 40. An electromechanical metering device 72 is attached to the base plate 71. The preferred metering device 72 uses an electric solenoid 74. The solenoid 74 is attached to one end of a pivot bar 75 which pivots on pivot support 77. The other end of the pivot bar 75 is biased into contact with material dispensing aperture 76 by a spring 78. The solenoid 74 is energized by the row control unit 60 to pivot the pivot bar 75 away from the material dispensing aperture 76, thereby allowing product to flow by gravity out of the container 40.

The solenoid 74 must be sealed from the product. Product entering the solenoid 74 can cause its premature failure. The solenoid end of the pivot bar 75, the spring 78 and the connection of the pivot bar 75 to the solenoid 74 are sealed by a cover (not shown) to prevent entry of product into the solenoid 74. The preferred method for pivoting the pivot bar 75 and sealing the solenoid cover is to include a round flexible washer (not shown) in the pivot support 77. This flexible washer, sometimes referred to as a living hinge, has a small hole in the center, smaller than the diameter of the pivot bar 75. The pivot bar 75 is inserted through the small hole in the flexible washer. The flexible washer allows the pivot bar 75 to pivot and seals the solenoid cover from the product.

The electronic memory circuit (i.e. unit) 80 is connected to the solenoid 74. A multi-conductor cable 82 and connector 83 are used to connect the electronic memory circuit 80 to the row control unit 60. In one embodiment of the present invention, the row control unit 60 directly applies electrical power to the solenoid 74 through power wires 81. In addition to connecting the row control unit 60 solenoid power to the solenoid 74, the electronic memory circuit 80 also includes a non-volatile memory device 85. The memory device 85 may be an E PROM or other suitable non-volatile memory device that has an electrically erasable programmable memory. The memory device 85 is equipped to handle 48 or more rows.

The combination of the electronic memory 85 and the product container 40 with attached metering device 72 may, in combination, form a material container capable of electronically remembering and storing data important to the container, the material dispensing system, and the agricultural product. Among the data which could be stored are: a serial number unique to that container, product lot number, type of product, metering calibration, date of filling, quantity of material in the container, quantity of material dispensed including specific rates of application, and fields treated. These stored data can be recalled and updated as needed. The stored data can also be used by a metering controller or pumping system by accessing specific calibration numbers unique to the container and make needed adjustments, by sounding alarms when reaching certain volume of product in a container, or keeping track of usage of the container to allow scheduling of maintenance.

Referring now to FIG. 3, in operation, the main control unit (i.e. master controller) 10 receives a desired dispensing rate from the operator via the display 12 and keypad 14. The main control unit 10 monitors the planter's 20 ground speed by the speed sensing device 16. Using the desired dispensing rate, the ground speed and basic dispensing characteristics for the metering device 72, command data for the row control units 60 are prepared. The preferred dispensing control for a solenoid type metering device 72 is to use a fixed rate for actuating the metering device 72, 0.5 seconds, and vary the on time (or duty cycle) of the metering device, 10% to 50%. The row control unit 60 modifies the duty cycle specified by the main control unit 10 to account the actual metering device 72 calibration data which was retrieved from the memory device 85. The row control unit 60 continues to operate the metering device 72 at the rate and duty cycle specified by the main control unit 10 until new commands are received from the main control unit 10. The main control unit 10 may calculate the quantity of material remaining in the product container 40.

As discussed above, the master controller 10 is connected to the power distribution box 15, which in turn, is connected to three junction boxes 55 via high speed serial communications links 50. The row control unit 60 has a flow sensor 62 as part of its electronic circuits. The flow sensor 62 senses the flow of material from the container 40. The main control unit 10 can monitor the flow sensors 62 and generate visual and audible alarms as required. The flow sensor 62 includes an infra-red light source positioned across from an infra-red light detector. These two components may be mounted on a printed circuit board which is part of the row control unit 60. (A hole is made in the board between the light source and the light sensor.) Alternatively, the flow sensor 62 may be a separate unit operatively connected to the row control unit 60. The dispensed product is guided between the light sensor and the light source. The logic circuit associated with the flow sensor 62 monitors for the presence of flow by intermittent interruptions of the light reaching the light sensor. Proper flow will cause intermittent interruptions of the light. A non-interrupted light will signal no material flowing from the container 40. A completely interrupted light will indicate a flow of the tubing after the flow sensor 62.

To operate the material dispensing system, it is necessary for the main control unit 10 to uniquely identify the row control unit 60, metering device and memory unit 70 pairs. Each metering device and memory unit 70 includes a unique electronic serial number in the memory device 85. Each row control unit 60 also has a unique electronic serial number. When the material dispensing system is initialized, the main control unit 10 must poll or query all the metering device and memory units 70 and row control units 60 to determine by serial number which units 70, 60 are attached to the planter 20. This is sufficient identification for the system to function. In the preferred embodiment, the operator should be able to refer to a row and its associated seed and material dispensing equipment as row x, rather than by the serial number of the metering device and memory unit 70 or by the serial number of the row control unit 60. To associate a particular metering device and memory unit 70 and row control unit 60 to a particular row, a row configuration method is provided.

The main control unit 10 is initialized in a configuration mode with no row control units 60 connected. The row control units 60 are then connected to the main control unit 10 via the power distribution box 15 and the junction boxes 55 (one at a time) in the order in which the operator would like them to represent. The first row control unit 60 connected would represent row one. This allows an operator who prefers to work from left to right to have the left most row, row 1, and an operator who prefers to work from right to left to have the right most row as row 1.

With, for example, 48 rows on a planter 20, it is necessary to control or limit the current drawn by the metering solenoids 74. In this example, if all 48 solenoids were operated simultaneously, the current demands could exceed the capacity of the operator's tractor.

The rate at which the metering device 72 is operated is typically 0.5 seconds. The metering device 72 is actually activated at a 10% to 50% duty cycle (10% to 50% of the rate). The solenoid is turned on at 0.5 second intervals for 0.05 to 0.25 seconds. The preferred method of varying the dispensing rate is to keep the rate fixed and vary the duty cycle. Minimum current demand can be achieved by sequencing the activation of each metering device 72. The optimum sequence time is defined as: Rate/Number of Rows. For a 4 row system operating at a rate of 0.5 seconds, the sequence time is 0.125 seconds (0.5 seconds/4). This means that the metering devices 72 are started at 0.125 second intervals. A variation of this sequencing is to divide the metering devices 72 into sections, and stagger the starting times of each section.

The system operates in the following manner: Material dispensing begins with the main control unit 10 sending each row control unit 60 a “start” command at the appropriate time (the sequence time). The row control unit 60 does not actually receive and use the sequence time value. Because of variations in the operation of the multiple row control units 60, the row control units 60 will drift away from the ideal sequencing. It is necessary to periodically issue a “re-sync” at approximately one minute intervals and basically restart each metering device 72 which re-synchronizes each row control unit 60 back to the main control unit's 10 time base.

An alternate power sequencing method requires the main control unit 10 to send a sequence time or delay time to each row control unit 60. The main control unit 10 then sends a start command to all row control units 60 simultaneously. Each row control unit 60 then activates the associated metering device 72 after the time delay previously specified.

After configuration 13 the operator is able to set product and application rate groups, as indicated by numeral designation 17. Typically, there are multiple groups of rows that are defined by the operator. The master controller and the secondary controllers are configured to control the multiple groups of rows simultaneously. However, it is within the purview of the invention that the operator defines a single group. Different groupings will be discussed below in detail. The operator can define the rates and products for each row, as indicated by numeral designation 18.

The material dispensing system features and capabilities include:

Controls application rate of material under varying operating conditions. The application rate can be set by the operator from an operator's console or can be automatically read from the material container meter unit.

Provides actual ground speed information if a ground speed sensor is attached. A typical ground speed sensor includes GPS, wheel rpm and radar. In lieu of a ground speed sensor, a fixed planting speed may be entered and used to distribute the granular product material.

The system monitors material flow and alerts the operator to no flow, empty container, or blocked flow conditions.

The system may monitor and track container material level for each row.

The system provides control information and data to a non-volatile memory for future downloading.

The system monitors the planter to allow product to be applied only when the planter is in the planting position.

A typical usage for this system is:

1) In some embodiments, for a new product container, the metering device and memory unit 70 may be attached to the product container 40 by either the container manufacturer or at the container filling site. In other embodiments, the metering device and memory unit 70 may be attached to the product container 40 by the grower.

2) A computer is connected to the metering device and memory unit 70. (In some embodiments this might be at the time of filling.) The following information is electronically stored in memory device 85:

Date

EPA chemical ID numbers

Container serial number

Suggested doses, such as ounces per acre for root worm, or ounces per acre for grubs, etc. These rates are specified by the EPA.

Meter calibration information, depending on type of metering device

Tare weight of the container

Weight of the full container

3) The container is sealed and prepared for shipping

4) The end user takes the product container 40 and attaches to dispensing implement, such as planter, sprayer, nurse tank, etc. The main controller 10 receives the information from the metering device and memory unit 70 pertaining to proper application rates and prompts the user to pick the desired rate. The row control unit 60 reads the metering device calibration information from the metering device and memory unit 70. This information is used in combination with commands from the main controller 10 to properly control the operation of the metering device 72. The user may enter a field ID number and any other required information such as number of rows, width between rows, etc. The user applies the product to the field. The main controller 10 monitors the ground speed and changes the amount being dispensed to keep a constant rate per acre. When the user finishes a field, additional fields may be treated. Field data, including field ID number, crop treated and quantity applied are recorded in the main controller's 10 non-volatile memory. This information may also be recorded in the metering device and memory unit 70 for later use by the distributor or product supplier.

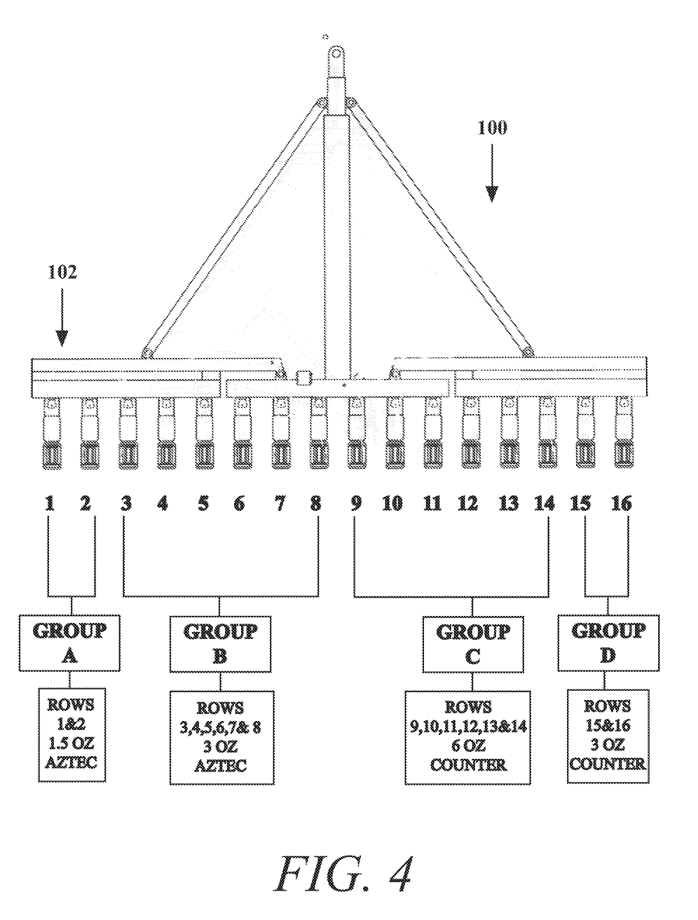

Referring now to FIG. 4, an example of row grouping on a corn planter is illustrated, designated generally as 100. In this example, there are four groups—Group A, Group B, Group C, and Group D—designated for a sixteen row planter 102. The grouping feature allows the growers (operators) to apply the correct product at different rates for designated rows in one planting operation. This example indicates that Group A includes rows 1-2 with Aztec® pesticide at a rate of 1.5 oz. per 1000 feet of row. Group B includes rows 3-8 with Aztec® pesticide at a rate of 3.0 oz. per 1000 feet of row. Group C includes rows 9-14 with Counter® pesticide at a rate of 6.0 oz. per 1000 feet of row. Group D includes rows 15-16 with Counter® pesticide at a rate of 3.0 oz. per 1000 feet of row.

This feature allows the grower to use different or the same product at different rates due to different seed traits on designated rows. For example, this feature allows use of a lower rate of product on triple stacked or quad stacked corn seed (root worm traits) on most rows on the planter but on designated rows the grower may be planting refuge corn seed (non-root worm trait or non GMO corn). This allows the use of higher rates of product for the non-traited corn.

This grouping feature allows the grower to use different products at different rates so they can do comparative evaluations to see which product and rate works best for their farming and production practices.

The grouping feature allows the growers to use different products and rates as required by a third party. For example, this feature can be used in seed corn production where the male rows typically receive a partial rate of insecticide.

The grouping feature allows seed corn companies to run different trials of products and rates on new seed stock production trials to determine what rates and products are best for their particular seed. For example, certain parent seed stock may respond (positive or negative) to certain crop protection products and rates of the products. This grouping feature allows the research to be accomplished in a timely fashion.

Setting row groups allows the grower to shut off certain rows while maintaining flow as needed from the rest of the row units. This saves product and money where the product is not needed.

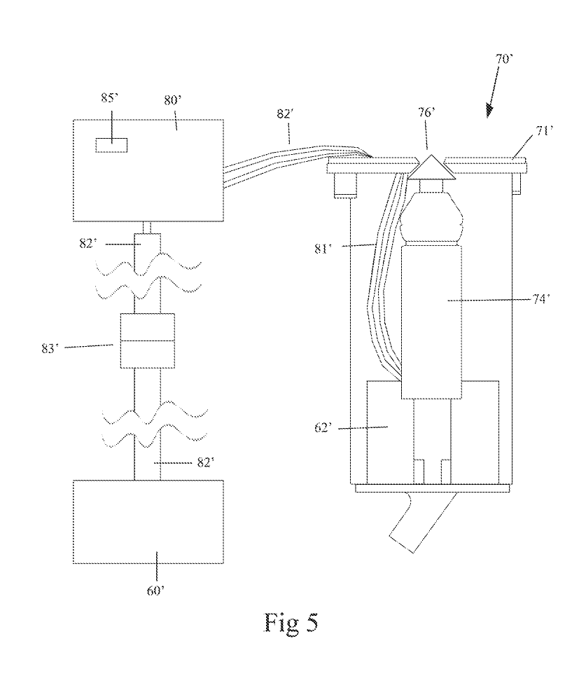

Other embodiments and configurations may be devised without departing from the spirit of the invention and the scope of the appended claims. For example, referring now to FIG. 5, a side view of an alternative meter system is illustrated, designated generally as 70′. In this system 70′ the pivot bar is omitted and the metering device 72′ is external from the container 40. This is done to eliminate one moving part (i.e. the pivot bar) if there is sufficient space. The meter system 70′ includes a metering device 72′ and memory unit 80′. A base plate 71′ is fastened to the bottom of the container 40 (not shown). The electromechanical metering device 72′ is attached to the base plate 71′. The preferred metering device 72′ uses an electric solenoid 74′. The solenoid 74′ is energized by the row control unit 60′ to retract the solenoid plunger away from the material dispensing aperture 76′, thereby allowing product to flow by gravity out of the container 40.

The solenoid 74′ must be sealed from the product. Product entering the solenoid 74′ can cause its premature failure. The solenoid 74′ is sealed by a cover to prevent entry of product into the solenoid 74′.

The electronic memory circuit (i.e. unit) 80′ is connected to the solenoid 74′. A multi-conductor cable 82′ and connector 83′ are used to connect the electronic memory circuit 80′ to the row control unit 60′. In one embodiment of the present invention, the row control unit 60′ directly applies electrical power to the solenoid 74′ through power wires 81′. In addition to connecting the row control unit 60′ solenoid power to the solenoid 74′, the electronic memory circuit 80′ also includes a non-volatile memory device 85′. The memory device 85′ may be an E PROM or any other suitable non-volatile memory device that has an electrically erasable programmable memory.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), General Purpose Processors (GPPs), Microcontroller Units (MCUs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software/and or firmware would be well within the skill of one skilled in the art in light of this disclosure.

In addition, those skilled in the art will appreciate that the mechanisms of some of the subject matter described herein may be capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communication link, a wireless communication link (e.g., transmitter, receiver, transmission logic, reception logic, etc.).

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

As mentioned above, other embodiments and configurations may be devised without departing from the spirit of the invention and the scope of the appended claims.

1. A system for dispensing agricultural products, comprising:
a) a master controller;
b) a power distribution box operatively connected to the master controller and a secondary power source;
c) a plurality of agricultural product containers;
d) a plurality of meter devices operatively connected to said product containers and configured to dispense agricultural products at metered rates from said containers to rows in a field;
e) a plurality of secondary controllers for actuating the plurality of meter devices, each secondary controller receiving command data from the master controller, via said power distribution box, and controlling the meter devices for dispensing in response to said command data;
wherein said master controller and said secondary controllers are configured to provide operator defined groups of rows, each of the rows in a group having an operator assigned dispensing rate and operator assigned agricultural product, said dispensing rate and agricultural product being controllable by the operator during operation according to planting needs.

2. The system of claim 1, wherein said groups of rows comprise multiple groups of rows, said master controller and said secondary controllers being configured to control said multiple groups of rows simultaneously.

3. The system of claim 1, wherein master controller and said secondary controllers are configured to dispense 48 or more different agricultural products in accordance with operator needs.

4. The system of claim 1, further including a plurality of junction boxes operatively positioned between said power distribution box and said plurality of subcontrollers.

5. The system of claim 1, wherein each secondary controller is associated with one product container.

6. The system of claim 1, wherein each secondary controller is associated with at least two chemical containers.

7. The system of claim 1, wherein each secondary controller receives calibration data for the meter devices and uses the calibration data in combination with the command data to control said meter devices.

8. The system of claim 1, wherein each chemical container includes means for retaining selected operating data, the selected operating data including an identifying serial number and calibration data for said meter devices.

9. The system of claim 1, wherein each said meter device includes an electromechanical apparatus, the application of actuation power to said electromechanical apparatus being controlled by one of said plurality of secondary controllers.

10. The system of claim 1, wherein each of said plurality of secondary controllers, at pre-determined intervals, applies electrical power to the metering means for a pre-determined time.

11. The system of claim 1, wherein the master controller receives input data, including type of agricultural product being dispensed and application rate for said agricultural product, and determines the electrical power application time and the time interval between such electrical power applications in response thereto.

12. The system of claim 1, wherein each secondary controller includes means for sensing the flow of agricultural product from said product container.

13. The system of claim 12, wherein each secondary controller includes an electronic circuit board, the means for sensing the flow of agricultural product being integral with the electronic circuit board.

14. A method for dispensing agricultural products, comprising the steps of:
a) providing a system arranged and constructed to dispense agricultural products from a plurality of agricultural product containers, said system for dispensing including a master controller, a plurality of meter devices operatively connected to said product containers and configured to dispense agricultural products at metered rates from said containers to rows in a field, and a plurality of secondary controllers for actuating the plurality of meter devices, each secondary controller receiving command data from the master controller and controlling the meter devices for dispensing in response to said command data;
b) defining groups of rows, each of the rows in a group having a defined dispensing rate and defined agricultural product; and,
c) dispensing said agricultural products in accordance with said defined groups of rows.

15. The method of claim 14, wherein said step of dispensing comprises controllably dispensing during operation according to planting needs.

16. The method of claim 14, wherein said step of defining groups of rows comprises defining multiple groups of rows, said master controller and said secondary controllers being configured to control said multiple groups of rows simultaneously.
